(19) United States
(12) Patent Application Publication
(10) Pub. No.: US 2025/0030796 A1
(43) Pub. Date: Jan. 23, 2025

(54) MESSAGE CONSOLIDATION PLATFORM

(71) Applicant: Impiricushealth Corp., Atlanta, GA (US)

(72) Inventors: Or Maoz, Atlanta, GA (US); Rafay Chaudhary, Atlanta, GA (US); Kok Seng Tan, Atlanta, GA (US); Alan Labouseur, Pleasant Valley, NY (US)

(21) Appl. No.: 18/772,407

(22) Filed: Jul. 15, 2024

Related U.S. Application Data
(60) Provisional application No. 63/527,208, filed on Jul. 17, 2023.

(51) Int. Cl. H04M 3/42

(52) U.S. Cl. CPC H04M 3/42221; H04M 3/42025

(57) ABSTRACT

Disclosed are various embodiments for a message consolidation platform. A computing device can receive a request to open a conversation feed where the request identifies a user. The computing device can retrieve a plurality of phone number pairs associated with the user, where each phone number pair includes a sender phone number and a recipient phone number. The computing device can obtain a plurality of pulses, where each pulse corresponds to a phone number pair. The computing device can then join the plurality of pulses to form the conversation feed.

### CROSS-REFERENCE TO RELATED APPLICATION

This application claims priority to, and the benefit of, U.S. Provisional Patent Application 63/527,208 entitled “MESSAGE CONSOLIDATION PLATFORM” which was filed on Jul. 17, 2023, and is incorporated by reference as if set forth herein in its entirety.

### BACKGROUND

In some cases, organizations may wish to communicate with a single user using multiple messaging touchpoints, such as phone numbers, emails, or other messages. For example, marketers may wish to use a marketing platform for messaging with an audience about multiple marketing campaigns, each of which may have its own touchpoint. Managing these communications across touchpoints is a cumbersome and time-consuming process which is prone to human error in missing communication lines.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a network environment according to various embodiments of the present disclosure.

FIG. 2 is an example user interface according to various embodiments of the present disclosure.

FIGS. 3A and 3B are sequence diagrams according to various embodiments of the present disclosure.

FIGS. 4A and 4B are example data flow diagrams according to various embodiments of the present disclosure.

FIG. 5 is a data flow diagram according to various embodiments of the present disclosure.

### DETAILED DESCRIPTION

Utilizing a marketing platform for messaging with an audience can facilitate sales and brand awareness. Marketers often wish to utilize short message service (SMS) or other mobile messaging channels to communicate with users. However, marketers might wish to utilize different touchpoints to communicate with users. For example, there might be different marketing campaigns that a marketer utilizes to communicate with users and potentially different marketers that are being serviced by a marketing service provider through a message platform. A touchpoint can be a phone number, email address, or other identifier that identifies a particular marketing campaign.

Currently, it is difficult for a marketer to view and manage all communications with a single user. A user can be a sales or marketing lead with which a marketer can communicate using the platform. Having to access multiple different platforms and services in order to view all correspondence with a single user is a cumbersome process prone to human error in missing a particular channel, mixing up which conversations have occurred on which channels, and various other errors. Accordingly, various embodiments of the present disclosure provide for a single platform where all communications with a single user can be consolidated and organized in order to reduce error and improve efficiency. According to various examples of the disclosure, a pulse runner can manage multiple pulses, or conversations, with a given user.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principles disclosed by the following illustrative examples.

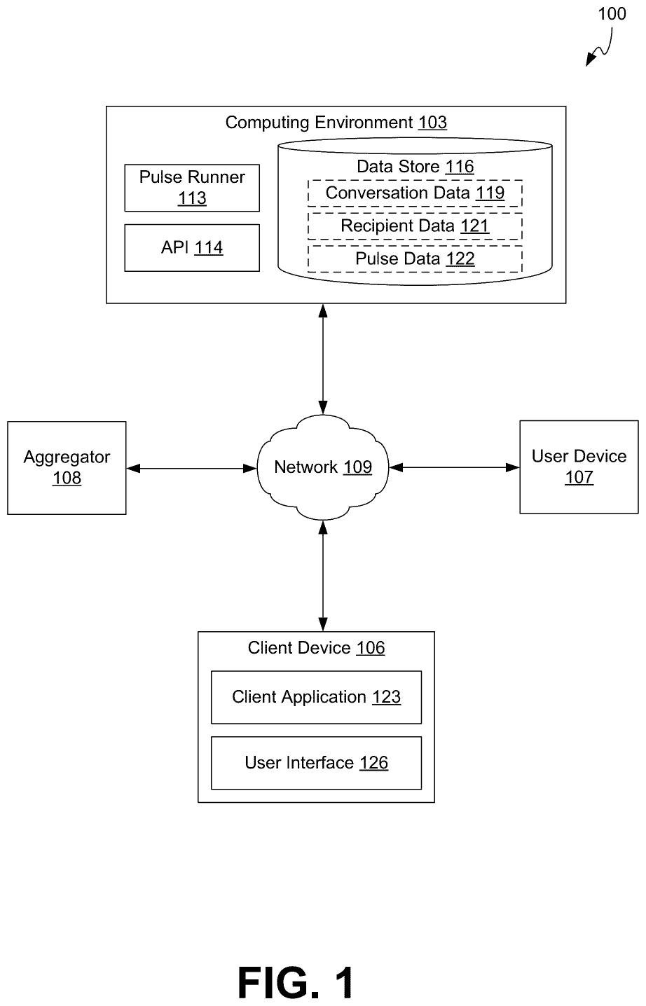

With reference to FIG. 1, shown is a network environment 100 according to various embodiments. The network environment 100 can include a computing environment 103, a client device 106, a user device 107, and an aggregator 108 which can be in data communication with each other via a network 109.

The network 109 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 109 can also include a combination of two or more networks 109. Examples of networks 109 can include the Internet, intranets, extranets, virtual private networks (VPNs), and similar networks.

The computing environment 103 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 103 can employ a plurality of computing devices that can be arranged in one or more server banks or computer banks or other arrangements. Such computing devices can be located in a single installation or can be distributed among many different geographical locations. For example, the computing environment 103 can include a plurality of computing devices that together can include a hosted computing resource, a grid computing resource or any other distributed computing arrangement. In some cases, the computing environment 103 can correspond to an elastic computing resource where the allotted capacity of processing, network, storage, or other computing-related resources can vary over time.

Various applications or other functionality can be executed in the computing environment 103. The components executed on the computing environment 103 include a pulse runner 113, an application programming interface (API) 114, and other applications, services, processes, systems, engines, or functionality not discussed in detail herein.

The pulse runner 113 is a software application which can serve as a central hub or messaging platform which can interact with various databases, systems, services, or applications to provide a plurality of conversations with a user in a single feed. The pulse runner 113 can interact with various components in the network environment to determine conversation pairs (e.g., a pair of telephone numbers used to have a conversation, etc.), retrieve messages associated with those conversation pairs, join conversations in one feed, and manage conversations from the central feed.

The API 114 can be representative of an application programming interface which serves to facilitate communications between various applications in the network environment 100. According to various examples, the API 114 can facilitate calls and responses between the pulse runner 113 and a data store 116.

Also, various data is stored in a data store 116 that is accessible to the computing environment 103. The data store 116 can be representative of a plurality of data stores 116, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 116 is associated with the operation of the various applications or functional entities described below. This data can include conversation data 119, recipient data 121, pulse data 122, and potentially other data. The data store 116, though represented as a single data store, can be implemented as different data stores that are accessible through application programming interfaces that are managed by separate platforms. For example, pulse data 122 might be accessible through the pulse runner 113 or a corresponding API 114, while conversation data 119 can be accessible through a separate platform that stores data about conversations from the messaging platform and user devices 107.

The conversation data 119 can represent information about conversations between the messaging platform facilitated by the pulse runner 113 and one or more user devices 107. Conversation data 119 can include inbound and outbound messages associated with a conversation pair (e.g., phone number pair for a conversation, etc.). The pulse runner 113 can utilize multiple originator or sender numbers or addresses to facilitate multiple conversations with a user device 107. The pulse runner 113 can also provide a user interface that can be accessed from a client device 106 in which the multiple conversations with a user device 107 can be viewed and managed.

Recipient data 121 corresponds to information about the end users who are receiving pulses. Recipient data 121 can include identifiers associated with a user, demographic information, marketing parameters, such as the types of products in which a user is interested, a professional specialty of the user, brands in which the user is interested, etc. In addition, recipient data 121 can include numbers, addresses or other contact information to facilitate communication as well as one or more opt-out statuses for each user which indicate whether the user has opted-out of communications for various individual pulses.

Pulse data 122 can include information about marketing campaigns or messaging campaigns. The pulse data 122 can identify a quantity of users, specific users, specific products or brands, or generalized targeting parameters so that the specific users in a campaign can be identified by the pulse runner 113. Pulse data 122 can also include a plurality of phone number pairs, or address pairs, which can be used to identify a specific conversation between the messaging platform and a user about a specific pulse or campaign. For example, a phone number pair can include a user phone number and a pulse phone number which was used for one particular pulse.

The client device 106 is representative of a plurality of client devices that can be coupled to the network 109. The client device 106 can include a processor-based system such as a computer system. Such a computer system can be embodied in the form of a personal computer (e.g., a desktop computer, a laptop computer, or similar device), a mobile computing device (e.g., personal digital assistants, smartphones, tablet computer systems, and similar devices), or other devices with like capability. The client device 106 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the client device 106 or can be connected to the client device 106 through a wired or wireless connection.

The client device 106 can be configured to execute various applications such as a client application 123. The client application 123 can be executed to access or render a user interface 126 in which conversations managed by the pulse runner 113 can be viewed and managed by a user. The client application 123 can represent a browser that accesses a web-based user interface 126 generated by the pulse runner 113 for administrators of the pulse runner 113.

A user device 107 is representative of a plurality of user devices, that may or may not be coupled to the network 109, belonging to a user with which the pulse runner 113 can communicate using a messaging protocol, such as short message service (SMS) or other open or proprietary messaging platforms. The user device 107 can include a processor-based system such as a computer system. Such a computer system can be embodied in the form of a personal computer (e.g., a desktop computer, a laptop computer, or similar device), a mobile computing device (e.g., personal digital assistants, smartphones, tablet computer systems, and similar devices), or other devices with like capability. The user device 107 can include one or more displays, such as liquid crystal displays (LCDs), gas plasma-based flat panel displays, organic light emitting diode (OLED) displays, electrophoretic ink (“E-ink”) displays, projectors, or other types of display devices.

The pulse runner 113 can facilitate marketing messaging with the user of the user device 107. A user can view marketing information or links provided by the pulse runner 113 and can respond to the pulse runner 113 by accessing links provided within a message or by responding to the message so that replies can be sent to the pulse runner 113 and acted on autonomously or with the assistance of an administrator utilizing the user interface 126 on a client application 123.

The aggregator 108 can be representative of a third-party service which facilitates the sending and receiving of messages by collecting messages and distributing them to an appropriate carrier for delivery to one or more user devices 107. In some embodiments, the aggregator 108 is an SMS aggregator 108 which collects SMS messages and distributes them to appropriate wireless carriers.

Next, a general description of the operation of the various components of the network environment 100 is provided. According to various examples, the pulse runner 113 can allow an administrator to manage multiple conversations with the user from the user interface 126. Utilizing the pulse runner 113, an administrator can manage multiple conversations from multiple originating phone numbers or other types of sender identifiers. However, these conversations will appear as if they are distinct from the perspective of the user device 107 because the pulse runner 113 can utilize different phone numbers or sender identifiers. The pulse runner 113 can aggregate these multiple conversations on a per-user basis within the user interface 126 and color code the conversations so that an administrator can more easily discern conversations from one another within the user interface 126.

For example, each conversation can correspond to a different marketing touchpoint. A first conversation can correspond to marketing material from Brand A about Product A, and a second conversation can correspond to marketing material from Brand B and Product B. These two conversations can be aggregated into a single message thread within the user interface 126, but the conversation about Product A can be shaded a different color than the conversation about Product B. However, from the perspective of the user, the conversation about Product A can appear distinct from the conversation about Product B because each is sent from a different phone number.

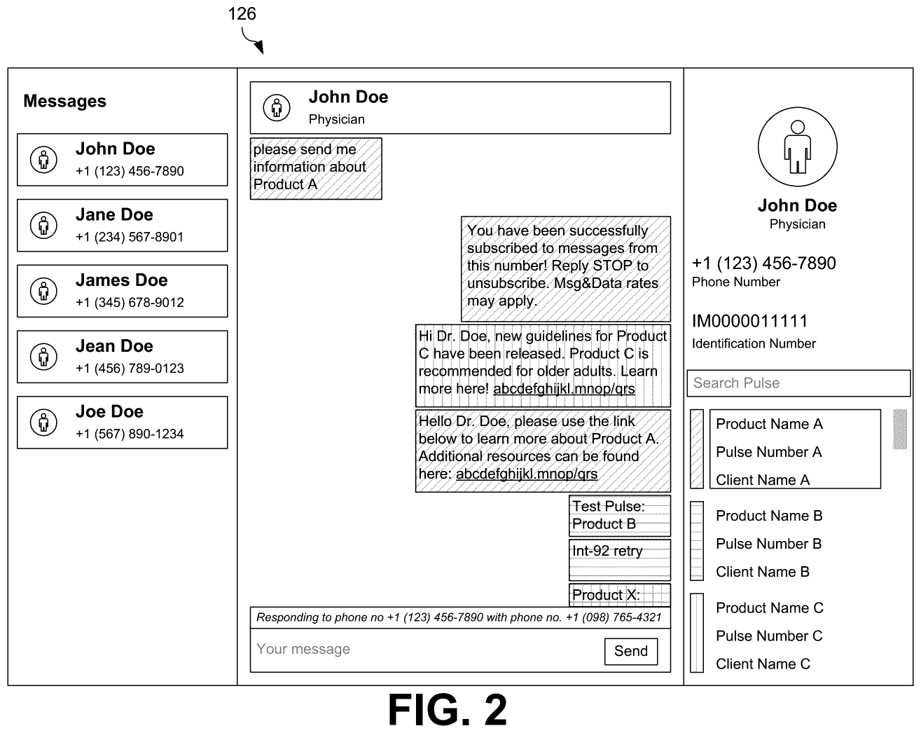

FIG. 2 illustrates an example of the user interface 126 that can be generated by the pulse runner 113 and rendered on a client device 106. The user interface 126 can illustrate how the pulse runner 113 can identify different conversations with a single recipient user (e.g., John Doe as shown in FIG. 2), which can be identified by a phone number or other identifier. The different conversations can be merged into a single message thread within the user interface 126. The different conversations can also be filled with a different color, shade, or pattern from one another so that an administrator can discern between them. For example, the example user interface 126 of FIG. 2 shows different shading for the pulses related to Product A, Product B, and Product C respectively. However, other forms of shading, coloring, etc. can be used to demarcate different pulses as well. Additionally, a client or administrator can respond to a particular conversation with the user distinct from another conversation within the message thread shown within the user interface 126.

The pulse runner 113 can identify conversations or pulses as distinct from one another based upon the phone number used as the originating number for the conversation. Additionally, the time between messages can be a mechanism utilized to distinguish between conversations. Messages that are sent from the pulse runner 113 after a threshold period of time, such a day, week, month, year, etc., can be considered separate conversations and colored/shaded/patterned separately from one another.

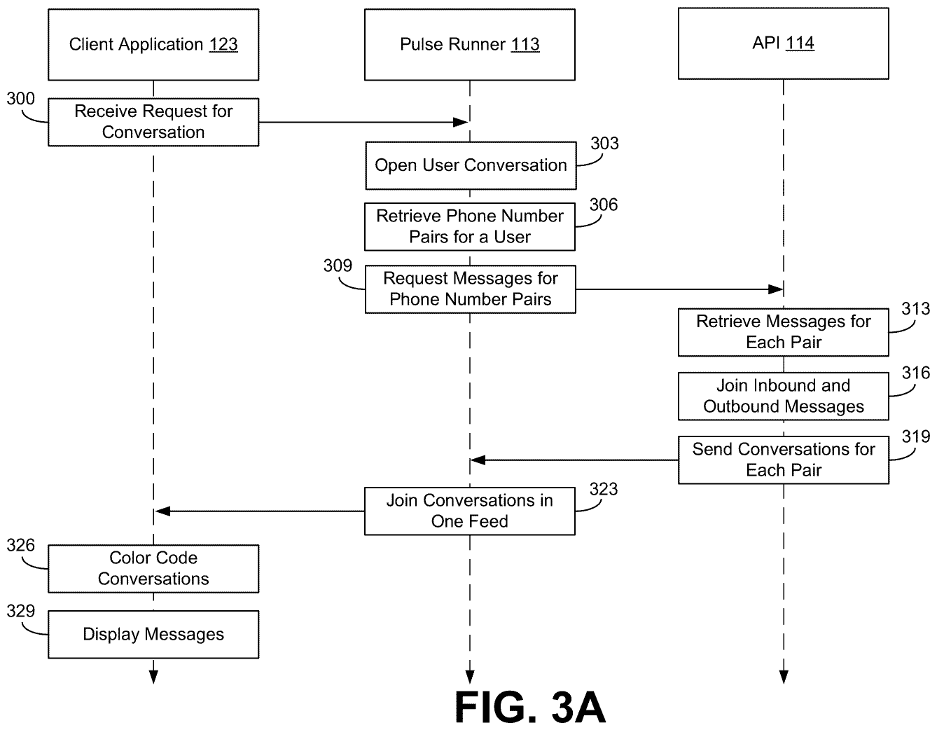

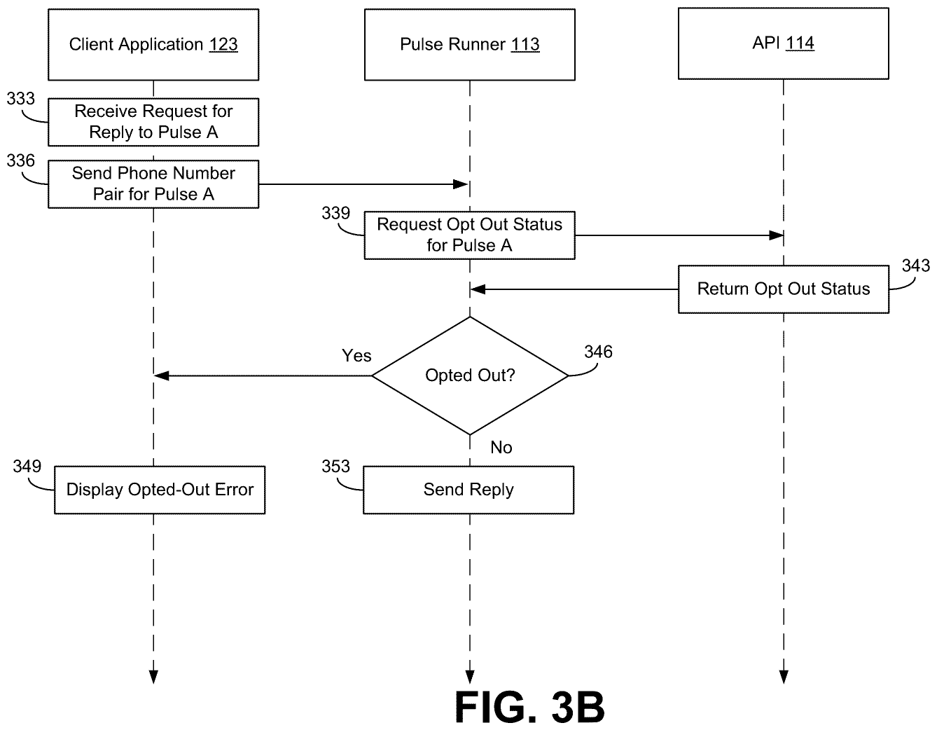

FIGS. 3A and 3B show sequence diagrams which provide examples of the interactions between the client application 123, the pulse runner 113, and an API 114. The sequence diagrams of FIGS. 3A and 3B provide merely an example of the many different types of potential interactions between the client application 123, the pulse runner 113, and an API 114. As an alternative, the sequence diagrams of FIGS. 3A and 3B can be viewed as depicting examples of elements of methods implemented within the network environment 100.

As shown at block 300, the client application 123 can receive a request for a conversation from a client through a user interface 126. The client application 123 can receive the request for a conversation with a particular user. A client of the user interface 126 can request a conversation through the client application 123 to view in the user interface 126. For example, the client can select a particular marketing target or message recipient in the messages view of the user interface 126. In some embodiments, the client application 123 can forward the request to the pulse runner 113.

At block 303, the pulse runner 113 can be executed to open a user conversation. In some embodiments, the pulse runner 113 opens the conversation based at least in part on receiving the request from the client application 123 at block 300.

At block 306, the pulse runner 113 can retrieve phone number pairs for a particular user. In some examples, the pulse runner 113 can maintain a pulse runner database that can store phone number pairs that relate a given conversation with a particular user or marketing target, such as a physician or health professional. The pulse runner 113 can fetch phone number pairs from the data store 116 that correspond to various conversations with the message recipient because the pulse runner 113 can maintain different conversations from different originating phone numbers with the recipient's single phone number. The phone number pairs represent a single recipient phone number and each originating phone number that is used to message the recipient. The pulse runner 113 can identify a plurality of phone number pairs associated with a user and retrieve them for use in the conversation feed. In some embodiments, the user can be identified from the request received at block 300.

Next, at block 309, the pulse runner 113 can communicate with an API 114 from which messages for the phone number pairs can be retrieved. The pulse runner 113 can fetch the messages for each phone number pair. According to various examples, the pulse runner can send a request to the API 114 to obtain conversation data 119. In some embodiments, the pulse runner can request messages for the phone number pairs identified at block 306.

At block 313, the API 114 can retrieve messages for each phone number pair identified from the request of block 309. In some examples, the API 114 can communicate with a database or data store 116 to retrieve the messages requested by the pulse runner 113. The messages can be retrieved from the data store 116. The API 114 can obtain conversation data 119 from the data store 116. The API 114 can retrieve messages for a single phone number pair or multiple phone number pairs at a time.

At block 316, the API 114 can join inbound and outbound messages that correspond to messages for the phone number pair. Using the conversation data 119 retrieved at block 313, the API 114 can identify a plurality of inbound messages and a plurality of outbound messages corresponding to the phone number pair identified in the request for messages at block 309. The API 114 can join the inbound and outbound messages together to form a conversation for each phone number pair. In some examples, the API 114 forms one conversation for each phone number pair based at least in part on the inbound and outbound messages. The API 114 can send these conversations to the pulse runner 113 in response to receiving the request for messages from block 309.

At block 323, the pulse runner 113 can join the conversations into a single feed. In some embodiments, the pulse runner 113 uses the conversations received from the API 114 at block 319 and joins the conversations into one feed. According to various examples, this block can involve time-ordering of inbound and outbound messages, as well as identifying pulses corresponding to each conversation. The pulse runner 113 can join all of the conversations returned by the API 114 for presentation in the user interface 126. The pulse runner 113 can then send the feed to the client application 123.

At block 326, the client application 123 can color code conversations in the feed received from the pulse runner 113. The client application 123 can assign each conversation for a given phone number pair a different color. For example, the client application 123 can take the feed received from the pulse runner 113 and color-code each inbound or outbound message in the feed according to the conversation or pulse to which the message belongs. In some embodiments, the client application 123 changes the color, shade, shape, or format of the message in order to differentiate between messages in different conversations.

At block 329, the client application 123 can display the messages by sending the color-coded feed to a user interface 126. The user interface 126 can display the feed based at least in part on the color-coding instructions from the client application 123.

Moving to FIG. 3B, the user interface 126 can incorporate a reply button for the latest inbound message for each conversation with the recipient. At block 333, the client application 123 can receive a request to reply to a particular pulse (e.g., Pulse A, etc.). In some embodiments, the client application 123 receives this request from a client interacting with the user interface 126.

At block 336, the client application 123 can determine a phone number pair for pulse A and send it to the pulse runner 113. The user interface 126 can allow a user of a client device to select which campaign or which originating phone number should be utilized to communicate with the message recipient or marketing target. From this interaction, the client application 123 can take the selection from the user interface 126 and determine which phone number pair corresponds to the selected message(s). Once the phone number pair has been determined, the client application 123 can forward the pair to the pulse runner 113.

Next, at block 339, the pulse runner 113 can request an opt-out status from an API 114. In some cases, prior to sending a message to a user from the user interface 126, the pulse runner 113 can automatically determine whether a message recipient, or marketing target, has previously opted out of receiving marketing or promotional messaging. In some embodiments, the pulse runner 113 can request the opt-out status from the API 114.

At block 343, the API 114 can determine the opt-out status associated with the user and return the opt-out status to the pulse runner 113. In some examples, the API 114 retrieves the status from a data store 116 or other system in the network environment. The status can be determined through inbound messages from the user requesting to opt-out or agreeing to participate, etc.

Next, at block 346, the pulse runner 113 can determine whether the recipient has opted-out of further communications. If the recipient has opted out of receiving marketing messaging, the pulse runner 113 can block the sending of a new message to the recipient's phone number and send an error to the client application 123, as shown at block 349. If the recipient has not opted out or remains opted-in, the pulse runner 113 can proceed to block 353 to send the reply. Depending on the determination of opted-out or not made at block 346, the pulse runner 113 will either proceed to block 349 or to block 353.

At block 349, in response to the pulse runner 113 determining that the client has opted-out of receiving further communications at block 346, the pulse runner 113 can send an error to the client application 123. The client application 123 can then cause the opted-out error message to be displayed in the user interface 126.

At block 353, in response to the pulse runner 113 determining at block 346 that the client has or remains opted-in for messaging, the pulse runner 113 can send the reply as requested at block 333. In some embodiments, the pulse runner 113 sends the reply to a user device 107.

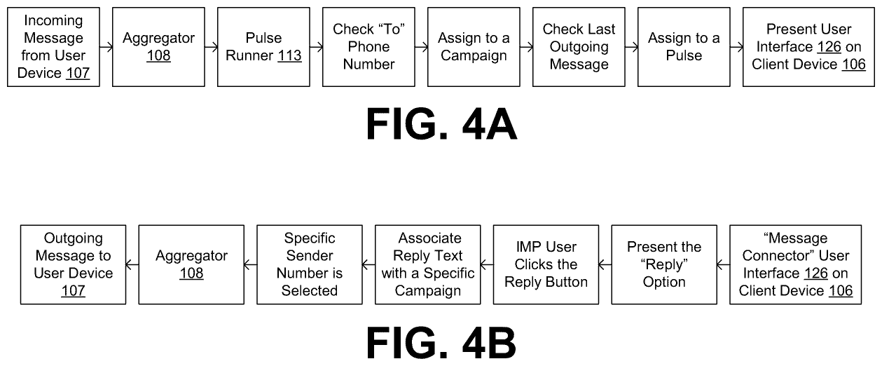

FIGS. 4A and 4B illustrate how data can flow from a user device 107 to the pulse runner 113 (4A) and vice versa (4B). In FIG. 4A, for messages sent from a user device 107 to the platform powered by the pulse runner 113, an incoming message from the user device 107 is detected and provided by an SMS aggregator 108 to the pulse runner 113. The pulse runner 113 can detect the phone number to which the message is sent by the user device 107 and determine with which marketing campaign the number is associated.

Next, the pulse runner 113 can identify the last outgoing message associated with the campaign and assign the message to a pulse, or to a conversation with a recipient/marketing target. The message can be provided to the user interface 126 for presentation with the color that is selected for the given campaign.

At FIG. 4B, for messages sent from the pulse runner 113 to a user device 107, a message can be obtained via the user interface 126 of a client device 106 for sending to a user device 107. In one example, a “reply” button can be provided for the last message in each campaign associated with a given message recipient. When the client of the pulse runner 113 user interface 126 selects the reply button, the reply text associated with the campaign for which the reply button is selected can be generated and a sender number selected for the message. The sender number can be linked to the campaign so that recipient replies to the message can be detected as being associated with that campaign. The message can be sent to the user device 107 by the pulse runner 113. In some examples, the pulse runner 113 can utilize an SMS aggregator 108 or API 114 provided by a third-party provider.

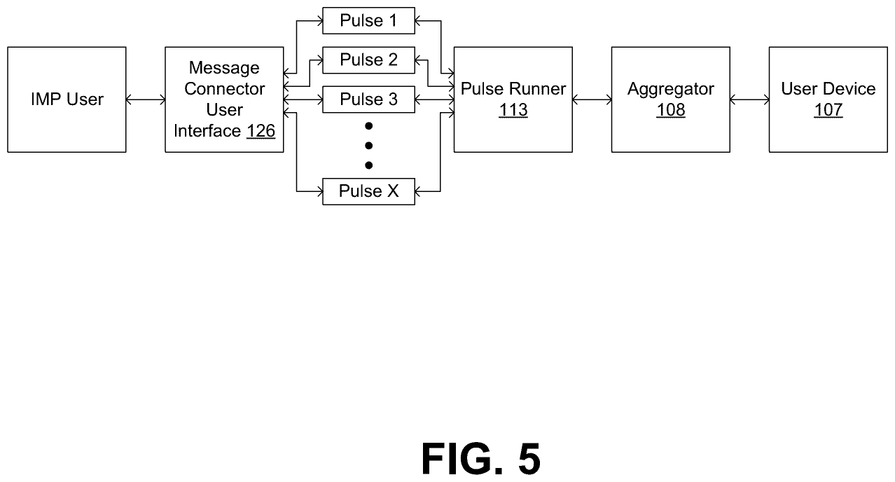

FIG. 5 illustrates an alternative data flow diagram showing how data flows through the platform powered by the pulse runner 113. An IMP user, or a user of the pulse runner 113, can utilize a message connector screen provided by the user interface 126. The message connector screen allows the user to view multiple pulses, pulses 1 . . . . X, with a given message recipient or marketing target. The user interface 126 can also allow the user to view pulses associated with multiple marketing targets. The pulse runner 113 can utilize an SMS aggregator 108, or a third-party messaging provider through an API 114 that allows the pulse runner 113 to send SMS messages to user devices 107 corresponding to marketing targets. In some implementations, rather than an SMS aggregator 108, an alternative or multiple messaging interfaces can be utilized, such as proprietary messaging platforms.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 103.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X, Y, or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
receive, from a client device, a request to open a conversation feed, the request identifying a user;
retrieve a plurality of phone number pairs associated with the user, each phone number pair of the plurality of phone number pairs including a sender phone number and a recipient phone number associated with the user;
obtain a plurality of pulses, each pulse of the plurality of pulses corresponding to a phone number pair of the plurality of phone number pairs;
join the plurality of pulses to form the conversation feed, wherein the pulses in the plurality of pulses are arranged in the conversation feed in chronological order; and
send, to the client device, the conversation feed in response to receiving the request to open the conversation feed.

2. The system of claim 1, wherein each pulse of the plurality of pulses comprises one or more inbound messages and one or more outbound messages.

3. The system of claim 1, wherein the machine-readable instructions, when executed, further cause the computing device to at least:
receive a request to reply to a pulse of the plurality of pulses;
identify the phone number pair corresponding to the pulse; and
determine an opt-out status of the user, the opt-out status corresponding to the pulse.

4. The system of claim 3, wherein the machine-readable instructions which, when executed, cause the computing device to determine the opt-out status, further cause the computing device to at least:
determine that the user is opted-in; and
send a reply to the pulse.

5. The system of claim 3, wherein the machine-readable instructions which, when executed, cause the computing device to determine the opt-out status, further cause the computing device to at least:
determine that the user is opted-out; and
send an opted-out error.

6. The system of claim 1, wherein the machine-readable instructions, when executed, further cause the computing device to at least send the conversation feed to a user interface.

7. The system of claim 1, wherein the machine-readable instructions, when executed, further cause the computing device to at least assign a display color to each pulse of the plurality of pulses.

8. A method, comprising:
receiving, from a client device, a request to open a conversation feed, the request identifying a user;
retrieving, by a computing device, a plurality of phone number pairs associated with the user, each phone number pair of the plurality of phone number pairs including a sender phone number and a recipient phone number associated with the user;
obtaining, by the computing device, a plurality of pulses, each pulse of the plurality of pulses corresponding to a phone number pair of the plurality of phone number pairs;
joining, by the computing device, the plurality of pulses to form the conversation feed, wherein the pulses in the plurality of pulses are arranged in the conversation feed in chronological order; and
sending, to the client device, the conversation feed in response to receiving the request to open the conversation feed.

9. The method of claim 8, further comprising:
receiving, by the computing device, a request to reply to a pulse of the plurality of pulses;
identifying, by the computing device, the phone number pair corresponding to the pulse; and
determining, by the computing device, an opt-out status of the user, the opt-out status corresponding to the pulse.

10. The method of claim 9, wherein determining the opt-out status further comprises at least:
determining, by the computing device, that the user is opted-in; and
sending, by the computing device, a reply to the pulse.

11. The method of claim 9, wherein determining the opt-out status further comprises at least:
determining, by the computing device, that the user is opted-out; and
sending, by the computing device, an opted-out error.

12. The method of claim 8, wherein each pulse of the plurality of pulses comprises one or more inbound messages and one or more outbound messages.

13. The method of claim 8, further comprising sending, by the computing device, the conversation feed to a user interface.

14. The method of claim 8, further comprising assigning, by the computing device, a display color to each pulse of the plurality of pulses.

15. A non-transitory, computer-readable medium, comprising machine-readable instructions that, when executed by a processor of a computing device, cause the computing device to at least:
receive, from a client device, a request to open a conversation feed, the request identifying a user;
retrieve a plurality of phone number pairs associated with the user, each phone number pair of the plurality of phone number pairs including a sender phone number and a recipient phone number associated with the user;
obtain a plurality of pulses, each pulse of the plurality of pulses corresponding to a phone number pair of the plurality of phone number pairs;
join the plurality of pulses to form the conversation feed, wherein the pulses of the plurality of pulses are arranged in the conversation feed in chronological order; and
send, to the client device, the conversation feed in response to receiving the request to open the conversation feed.

16. The non-transitory, computer-readable medium of claim 15, wherein the machine-readable instructions, when executed, further cause the computing device to at least:
receive a request to reply to a pulse of the plurality of pulses;
identify the phone number pair corresponding to the pulse; and
determine an opt-out status of the user, the opt-out status corresponding to the pulse.

17. The non-transitory, computer-readable medium of claim 16, wherein the machine-readable instructions which, when executed, cause the computing device to determine the opt-out status, further cause the computing device to at least:
determine that the user is opted-in; and
send a reply to the pulse.

18. The non-transitory, computer-readable medium of claim 16, wherein the machine-readable instructions which, when executed, cause the computing device to determine the opt-out status, further cause the computing device to at least:
determine that the user is opted-out; and
send an opted-out error.

19. The non-transitory, computer-readable medium of claim 15, wherein the machine-readable instructions which, when executed, cause the computing device to at least:
assign a display color to each pulse of the plurality of pulses; and
send the conversation feed to a user interface.

20. The non-transitory, computer-readable medium of claim 15, wherein each pulse of the plurality of pulses comprises one or more inbound messages and one or more outbound messages.
